(19) United States
(12) Patent Application Publication
(10) Pub. No.: US 2014/0217790 A1
(43) Pub. Date: Aug. 7, 2014

(54) Quick Release Bench Seat and Hitch Apparatus and Methods of Using the Same

(71) Applicant: Alfred D. Stavros, Hawthorn Woods, IL (US)

(72) Inventor: Alfred D. Stavros, Hawthorn Woods, IL (US)

(21) Appl. No.: 14/046,358

(22) Filed: Oct. 4, 2013

Related U.S. Application Data
(60) Provisional application No. 61/709,961, filed on Oct. 4, 2012.

(51) Int. Cl. B60N 2/24

(52) U.S. Cl. CPC B60N 2/24
USPC 297/217.7

(57) ABSTRACT

A bench apparatus utilized with a hitch mechanism is disposed on the rear of vehicles. Specifically, the bench apparatus of the present invention, preferably having a quick-release hitch, may be disposed on the rear of a vehicle, such as a car, truck, tractor, or other vehicle, for allowing individuals to sit thereupon and be transported. The hitch apparatus allows quick and easy placement and removal of the same to the vehicle. Methods of using the same are further provided.

The present invention claims priority to U.S. Provisional Patent Application No. 61/709,961 entitled “Quick Release Bench Seat And Hitch Apparatus And Methods Of Using The Same,” filed Oct. 4, 2012, which is incorporated herein by reference in its entirety.

### TECHNICAL FIELD

The present invention relates to a bench seat apparatus utilized with a hitch mechanism for disposing on vehicles. Specifically, the bench seat apparatus of the present invention, preferably having a quick-release hitch, may be quickly and easily disposed on and/or remove from a vehicle, such as a car, truck, tractor, or other vehicle, for allowing individuals to sit thereupon and be transported. The hitch apparatus allows quick and easy placement and removal of the same to the vehicle. Methods of using the same are further provided.

### BACKGROUND

It is, of course, generally known to transport individuals in vehicles. In some cases, however, it may be difficult to move individuals within a vehicle that may not have sufficient space to carry the individuals. Moreover, it may be desirable for individuals to be transported outside of the vehicle, giving the individuals better views of surrounding environments. In addition, individuals may wish to be transported to otherwise inaccessible locations requiring the use of specialized transportation machinery, such as a tractor or the like, making it difficult to transport large numbers of individuals because of the size of the vehicle.

In addition, certain individuals may have mobility issues making it difficult for the individuals to easily enter a vehicle for transportation of the same. Indeed, it may be difficult for an individual who has mobility problems to manipulate the doors of a vehicle, step up and over the doorway into a vehicle, and manipulate his or her body to fit within the interior vehicle space.

A need, therefore, exists, for an apparatus and methods of using the same providing a seating area for individuals that may be easily accessible to the individuals. Moreover, a need exists for an apparatus and methods of using the same allowing individuals to be transported from one location to another by a vehicle that may otherwise have difficulty seating the individuals.

In addition, a need exists for an apparatus and methods of using the same allowing individuals with mobility problems to easily access and sit within a means for transporting the individuals. Further, a need exists for an apparatus and methods of using the same that allows for expanded seating for individuals who wish to be transported by a vehicle.

Moreover, a need exists for an apparatus and methods of using the same that provide a bench for sitting thereon that may be attached to a vehicle utilizing the vehicle's hitch mechanism. In addition, a need exists for an apparatus and methods of using the same that allow for easy attachment and removal of the same.

### SUMMARY OF THE INVENTION

The present invention relates to a bench seat apparatus utilized with a hitch mechanism for disposing on vehicles. Specifically, the bench seat apparatus of the present invention, preferably having a quick-release hitch, may be disposed on a vehicle, such as a car, truck, tractor, all-terrain vehicle (ATV) or other vehicle, for allowing individuals to sit thereupon and be transported. The hitch apparatus allows quick and easy placement and removal of the same to the vehicle. Methods of using the same are further provided.

To this end, in an embodiment of the present invention, a bench seat apparatus for transporting individuals via a vehicle is provided. The bench seat apparatus comprises a support floor for supporting a bench seat, the bench seat attached to the support floor via a plurality of legs. The support floor having a support frame connected to a central hitch beam for connecting to a box beam of a vehicle.

It is, therefore, an objective and advantage of the present invention to provide an apparatus and methods of using the same providing a seating area for individuals that may be easily accessible to the individuals.

Moreover, it is an objective and advantage of the present invention to provide an apparatus and methods of using the same allowing individuals to be transported from one location to another by a vehicle that may otherwise have difficulty seating the individuals.

In addition, it is an objective and advantage of the present invention to provide an apparatus and methods of using the same allowing individuals with mobility problems to easily access and sit within a means for transporting the individuals.

Further, it is an objective and advantage of the present invention to provide an apparatus and methods of using the same that allows for expanded seating for individuals who wish to be transported by a vehicle.

Moreover, it is an objective and advantage of the present invention to provide an apparatus and methods of using the same that provide a bench for sitting thereon that may be attached to a vehicle utilizing the vehicle's hitch mechanism.

In addition, it is an objective and advantage of the present invention to provide an apparatus and methods of using the same that allow for easy attachment and removal of the same.

Additional features and advantages of the present invention are described in, and will be apparent from, the detailed description of the presently preferred embodiments and from the drawings.

### BRIEF DESCRIPTION OF THE DRAWINGS

The drawing figures depict one or more implementations in accord with the present concepts, by way of example only, not by way of limitations. In the figures, like reference numerals refer to the same or similar elements.

FIG. 1 illustrates a rear view of a prior art tractor having a hitch mechanism.

FIG. 2 illustrates a perspective view of a bench trailer attached to a tractor in an embodiment of the present invention.

FIG. 3 illustrates a rear view of a bench trailer attached to a tractor in an embodiment of the present invention.

FIG. 4 illustrates a close-up perspective view of a hitch attachment and support apparatus for the bench trailer attachment for a vehicle.

FIG. 5 illustrates a close-up view of a hitch attachment and support apparatus attached to a tractor in an embodiment of the present invention.

### DETAILED DESCRIPTION OF THE PRESENTLY PREFERRED EMBODIMENTS

The present invention relates to a bench seat apparatus utilized with a hitch mechanism for disposing on the rear of vehicles. Specifically, the bench seat apparatus of the present invention, preferably having a quick-release hitch, may be disposed on the rear of a vehicle, such as a car, truck, tractor, or other vehicle, for allowing individuals to sit thereupon and be transported. The hitch apparatus allows quick and easy placement and removal of the same to the vehicle. Methods of using the same are further provided.

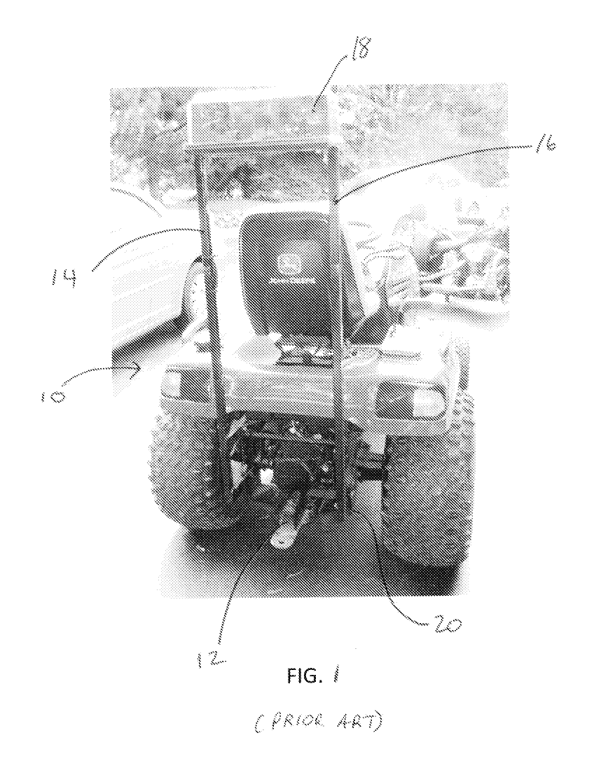

Now referring to the figures, wherein like numerals refer to like parts, FIG. 1 illustrates a prior art image of a tractor 10. Although the present invention describes the vehicle as, mainly, a tractor, it should be noted that the present invention described herein may be attached onto any vehicle having a hitch mechanism, as described herein, such as an automobile, a truck, a tractor, an ATV, as shown, and other like vehicles. Moreover, although the present invention is shown disposed on the rear of a vehicle, it should be noted that some vehicles having hitch mechanisms on the front thereof, may allow bench seat apparatuses of the present invention to be attached thereto, transporting individuals on the front of a vehicle. Of course, vehicles having hitch mechanisms both on the front and back of the vehicles may include two bench seat apparatuses of the present invention, a first disposed on the front of the vehicle and a second disposed on the rear of the vehicle, for transporting individuals thereon. In another embodiment, a bench seat apparatus may be provided on side of the vehicle, either on the front or the back, and counterweights may be provided on the opposite side of the vehicle, in cases where the vehicle is light enough to require counterweights due to the weight of the bench seat apparatus, individuals on the bench seat apparatus, and/or any other items stored on the bench seat apparatus, such as beneath the bench seat, as described in more detail below.

As illustrated in FIG. 1, the tractor 10 may include a box beam 12 for receiving a hitch beam (not shown in FIG. 1) that may extend from the bench seat apparatus of the present invention, as described below. The tractor 10 further comprises a pair of vertical posts 14, 16 supporting warning lights 18, although these are not necessary for the present invention. However, the vertical posts 14, 16 may provide additional support for the bench seat apparatus of the present invention. The box beam 12, as illustrated in FIG. 1, sits on a support structure 20 situation rearwardly of the tractor 10.

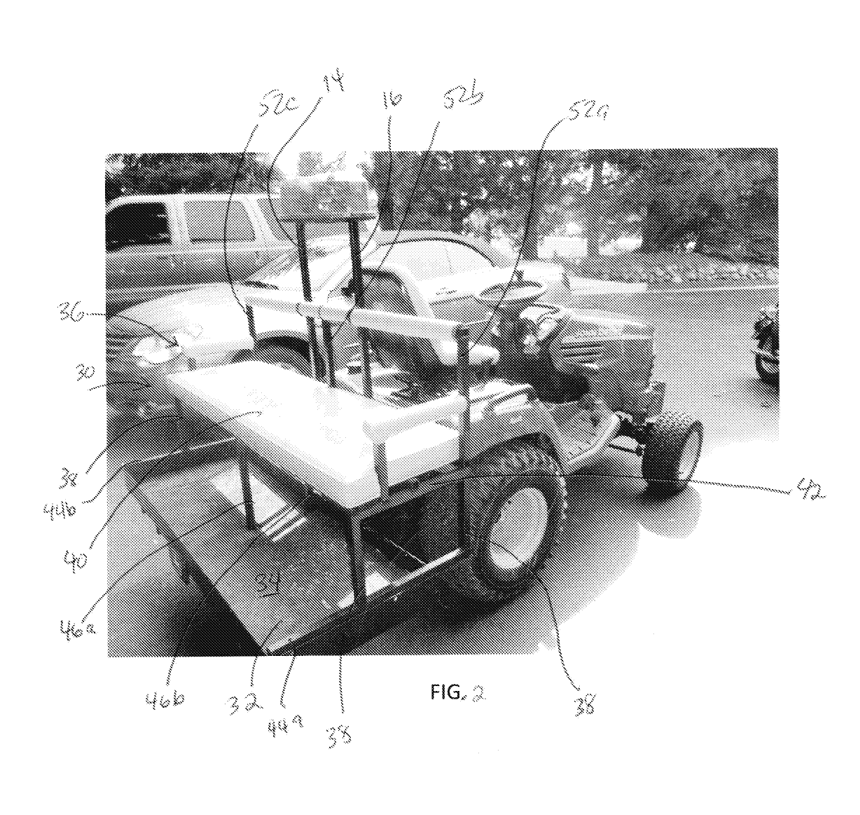

Now referring to FIG. 2, a bench seat apparatus 30 of the present invention is illustrated. The bench seat apparatus 30 may comprise a support floor 32, which may comprise a flat support panel 34 or other grid or structure having multiple vertically disposed walls, preferably in a tray configuration, the support floor providing a base of support for the remainder of the bench seat apparatus 30, and providing the attachment support for the attachment hitch beam, described herein.

The support floor 32 may have a bench seat structure 36 disposed thereon, and the bench seat structure 36 may comprise a plurality of vertically disposed legs 38 extending from the support floor 32 to an extended seat 40 situated on a horizontal frame 42, which may be attached to the plurality of vertically disposed legs 38. The extended seat 40 may be configured for individuals to sit thereon, with their feet on the support floor 32. A space may be provided beneath the extended seat 40 for storage of items on the support floor 32.

The vertically disposed legs 38 may be attached to horizontal support bars 44a, 44b, which may be attached to the support floor 32 on the sides thereof. Central support legs 46a, 46b may extend from the support floor 32 upwardly to the frame 42 supporting the extended seat 40. In a preferred embodiment, the central support legs 46a, 46b extend through the support floor 32 to a central support beam (not shown in FIG. 2) disposed beneath the support floor 32.

It should be noted that the bench seat apparatus component structures, including the support floor 32, vertical legs 38, central support legs 46a, 46b, frame 42, horizontal support bars 44a, 44b, and other components of the present invention may preferably be made of a strong and durable material, such as steel, that may provide sufficient support for individuals sitting on the bench seat apparatus 30. Ultimately, the bench seat apparatus 30 supports the weight of one or more individuals that may sit upon the extended seat 40. The component parts described herein may be attached together as apparent to one having ordinary skill in the art. Preferably, steel components providing structural integrity of the bench seat apparatus 30 may be welded together. Other parts may be attached together via bolts, screws, or the like.

The extended seat 40 may preferably be padded for comfort, although this is not necessary and the present invention should not be limited in this manner. In addition, the extended seat 40 may include extended armrests 48a, 48b extending from frame 42 and having padding thereon for comfort.

Back rest 50 may extend from vertical back posts 52a, 52b, 52c, supporting a horizontal beam 54 having padding thereon. The back rest 50 may allow individuals to rest their backs thereon as they are transported on bench apparatus 30. In a preferred embodiment, the horizontal beam 54 is attached to vertical posts 14, 16 via screws, bolts or the like, and may provide additional support for the bench seat apparatus 30. As shown in FIG. 2, the padding may be interrupted at locations where the horizontal beam 54 is attached to the vertical posts 14, 16.

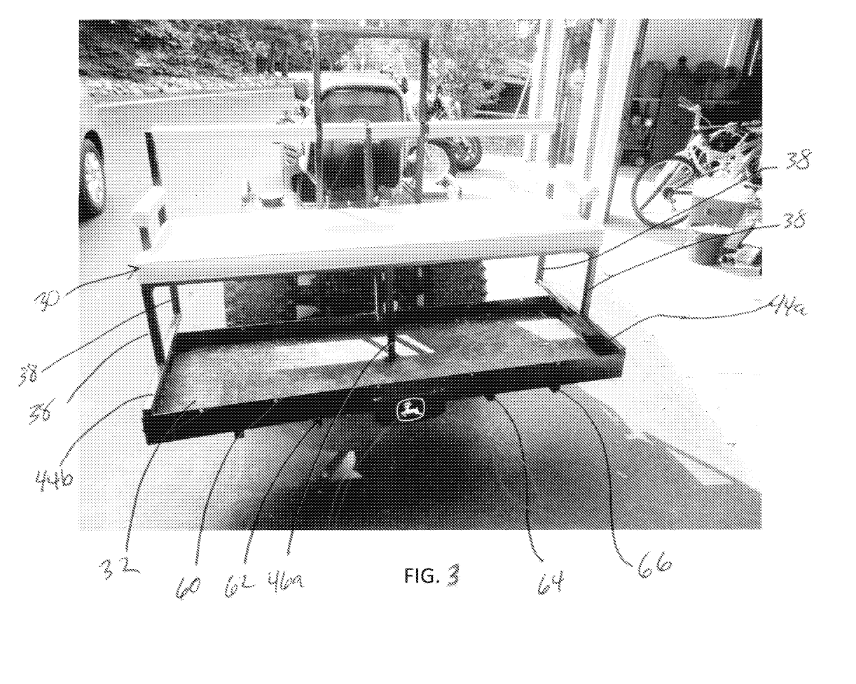

Now referring to FIG. 3, a rear view of the bench seat apparatus 30 is shown. The bench seat apparatus 30 further comprises a plurality of horizontal support beams 60, 62, 64, 66 forming a framework for supporting the support floor 32 disposed beneath the support floor 32.

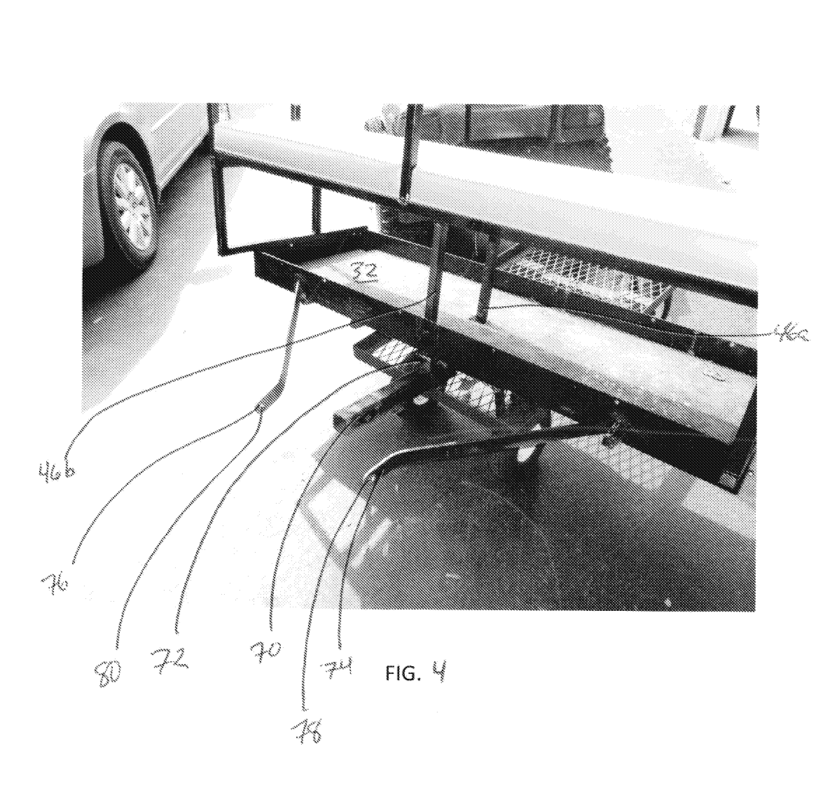

FIG. 4 illustrates a bench seat apparatus 30 of the present invention separated from a vehicle, illustrating the attachment mechanism useful for attaching the same to the vehicle. Specifically, a central hitch beam 70 may extend outwardly from a location beneath the support floor 32, and may be attached to a central support beam 72 that extends directly beneath the support floor 32. Indeed, as noted above, the central support legs 46a, 46b, may be disposed through the support floor 32 and may be connected to the central support beam 72.

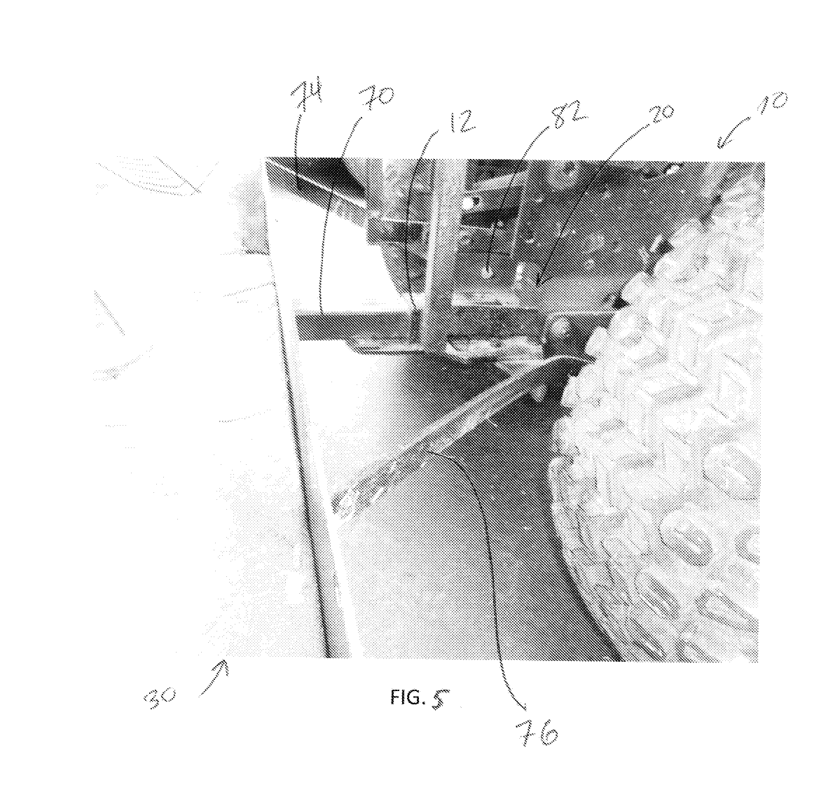

The central hitch beam 70 may extend and interconnect with a box beam attached to a vehicle, thereby uniting the bench seat apparatus 30 of the present invention with the vehicle. Preferably, the central hitch beam 70 is interconnected with the box beam via a quick-release hitch apparatus. Angled support struts 74, 76 may extend from the support floor 32 and may be attachable to one or more support structures on the vehicle, as shown in more detail in FIG. 5. The support struts 74, 76 may include apertures 78, 80 for receiving bolts for bolting to one or more support structure on the vehicle.

Alternatively, the support struts 74, 76, in a preferred embodiment of the present invention, may be angled and manipulated such that the apertures 78, 80 align with an aperture on the box beam 12 for receiving a pin-type fastener or a bolt for holding the central hitch beam 70 in place. A bolt may be preferred to more securely lock the support struts 74, 76 and the central hitch beam onto the box beam, providing additional support and structural integrity. Thus, the pin-type fastener or bolt may preferably serve the additional function of locking the support struts 74, 76 in place on the box beam 12, instead of other support structure on the vehicle. The pin-type fastener, thus, may extend through both support struts, the box beam 12 and the central hitch beam 70, locking all components into place.

Now referring to FIG. 5, a close-up view of the attachment of the bench seat apparatus 30 to the vehicle 10 (tractor) is illustrated. The central hitch beam 70 may extend within box beam 12 of the tractor 10, and may be connected thereto by a pin-type fastener, allowing for quick-release of the bench seat apparatus 30 from the tractor 10 by releasing the pin-type fastener and pulling the central hitch beam 70 from the box beam 12, as is apparent to one of ordinary skill in the art.

Support struts 74, 76 may be attached to support structure 20 of the tractor 10, as illustrated in FIG. 5. Specifically, bolts may be used to connect the support struts 74, 76 to the support structure 20. As illustrated in FIG. 5, bolt 82 may connect through support structure 20 to support strut 74. Another bolt (not shown) may connect support strut 76 to support structure 20.

Alternatively, as noted above, support struts 74, 76 may be attached directly to the box beam 12 on opposite sides thereof, and be held in place by the pin-type fastener or a bolt extending through apertures 78, 80, thereby locking the support struts and the central hitch beam 70 to the box beam 12.

In practice, the support structure provided, as detailed herein, allows individuals to sit with comfort on the bench seat apparatus 30 of the present invention, hitched to a vehicle and towed behind the vehicle. Preferably, the bench seat apparatus 30 does not have any portion that touches the ground in any manner, and simply extends from the rear of the vehicle 10, as illustrated herein. The vehicle shown herein is a tractor, although any vehicle may be used where the bench seat apparatus 30 may be easily attached via a hitch apparatus, as described herein. Thus, individuals may be transported from one location to another with ease and comfort, especially with vehicles that may not have sufficient seating for the same.

It should be noted that various changes and modifications to the presently preferred embodiments described herein will be apparent to those skilled in the art. Such changes and modifications may be made without departing from the spirit and scope of the present invention and without diminishing its attendant advantages.

I claim:

1. An apparatus for transporting individuals via a vehicle, the apparatus comprising:
a support floor for supporting a bench seat, the bench seat attached to the support floor via a plurality of legs; and
a support frame connectable to a central hitch beam for connecting the support floor to a box beam of a vehicle.
